(19) United States
(12) Patent Application Publication
(10) Pub. No.: US 2013/0110629 A1
(43) Pub. Date: May 2, 2013

(54) READER PROFILE-AIMED ADVERTISING METHOD

(71) Applicant: Dante Monteverde, Las Vegas, NV (US)

(72) Inventor: Dante Monteverde, Las Vegas, NV (US)

(21) Appl. No.: 13/286,399

(22) Filed: Nov. 1, 2011

(51) Int. Cl. G06Q 30/02

(52) U.S. Cl. 705/14.55; 705/14.66

(57) ABSTRACT

A method, system and apparatus for delivering an advertisement, such as a group coupon, to a user. The user can input information relevant to the user into a user profile, which can then be used to provide targeted advertisements to the user based on the information input into the profile. The user may also provide on-demand requests for advertisements to receive advertisements relevant to the user based on the user profile information.

### TECHNICAL FIELD OF THE INVENTION

The present application relates generally to online or computer-delivered advertising. More particularly, the present application relates to a method and system for providing a user with preconfigured, selected advertisements based on information obtained from a user profile.

### BACKGROUND OF THE INVENTION

Online advertisements, such as “deal of the day” coupons, are a well-known manner to communicate commercial offers to potential consumers. Advertisements can include graphics and text to entice the consumer to purchase the product or service, and can be displayed more prominently or in a more noticeable position based on the amount of money paid by the vendor to have the advertisement displayed. This so-called “bid-for-placement” system has developed a market of online advertising where the consumer is more prominently targeted with advertisements from a highest-paying bidder as compared to lower-paying bidders.

Conventional pay-for-placement advertisements do not account for the differences in the many users that are targeted, however. For example, the highest bidding advertisement can include a sports-theme intended to be directed toward males, but, due to conventional distribution schemes, is also delivered to females, which have no interest in the advertisement. As a result, the advertisements are not tailored to individual qualities of potential consumers and intended recipients that view advertisements.

More recent online advertising techniques attempt to tailor advertising toward a specific group of users by automatically retrieving information from the user during the use of the user's computer or mobile device. For example, advertising can be specifically tailored to the user based on the user having visited a website in the past, or based on the user's location as determined by a GPS sensor or the user's IP address. For example, the user could be subjected to an advertisement for BMW® vehicles if the user previously visited the website for BMW®. Similarly, the user could be subjected to an advertisement for a BMW dealer located near the user based on the IP address or GPS coordinates of the user.

The above advertising method is linked more to a machine than to a user, however, where the user's computer provides information relevant to the user's use of a computer, rather than the user himself/herself. As a result, many advertisements are directed to users who do not find them relevant based on previously visited websites or IP addresses. For example, the user can be targeted with women's jewelry advertisements based on a recent visit to a website where the user purchased jewelry, but has no interest in purchasing additional jewelry. Therefore, such advertisement was a waste, as the user is not interested in the advertisement.

Moreover, the above advertising methods provide the same advertisement for a given product, regardless of the user viewing the advertisement. For example, the same male sports figure may be used to advertise a product to both males and females, even though a male sports figure directed toward male consumers and a female sports figure directed toward female consumers may be more fruitful.

### SUMMARY OF THE INVENTION

The present application discloses a system, method and apparatus for delivering tailored advertisements to users based on information obtained in user-specific profiles previously compiled by the user. Accordingly, the user profiles are directed more to the user, and less to the computing device used by the user (e.g., the computer or mobile phone of the user), so that advertisements can be targeted to users based on factors such as, for example, the location, sex, age, race, nationality, or education level of the user. Therefore, an advertisement choice can be selected for a particular product and different users can be subjected to different advertisements for the same product to provide a more targeted marketing technique.

In addition, the present application discloses a method that allows the user to request advertisements in an on-demand format. The on-demand request can require the user to create a temporary user profile and can seek an advertisement for the user targeted to the user's specific interests and qualities, as input into the user profile.

In particular, the present application discloses a method receiving input from a user to establish a user profile including information specific to the user; selecting one of a plurality of advertisement choices as the advertisement based on the information, wherein each of the advertisement choices represents a common product or service; and delivering the advertisement to the user.

The present application also discloses a method including receiving a request from a user to receive an advertisement, the request including information specific to the user and input by the user; selecting one of a plurality of advertisement choices as the advertisement based on the information, wherein each of the advertisement choices represents a common product or service; and delivering the advertisement to the user.

Also, the present application discloses a user device including an interface adapted to receive input by a user; a processor operatively coupled to the interface; and a computer-readable medium operatively coupled to the processor and adapted to store a computer program having instructions for receiving a request from a user to receive an advertisement, the request including information specific to the user and input by the user; selecting one of a plurality of advertisement choices as the advertisement based on the information, wherein each of the advertisement choices represents a common product or service; and causing the delivery of the advertisement to the user.

Also disclosed is a user device including an interface adapted to receive input by a user; a processor operatively coupled to the interface; and a computer-readable medium operatively coupled to the processor and adapted to store a computer program having instructions for receiving a request from a user to receive an advertisement, the request including information specific to the user and input by the user; selecting one of a plurality of advertisement choices as the advertisement based on the information, wherein each of the advertisement choices represents a common product or service; and causing the delivery of the advertisement to the user.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic diagram of an embodiment of the present application as implemented within a network;

FIG. 2 is a schematic diagram of a user device according to the present application;

FIG. 3 is a flow chart illustrating an embodiment of the present application;

FIG. 4 is another flow chart illustrating an embodiment of the present application;

FIG. 5 is an illustration of a user profile according to the present application;

### DETAILED DESCRIPTION OF THE EMBODIMENTS

While the present invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated.

The present application discloses a method, system and apparatus for delivering an advertisement, such as, for example, a group coupon, to users. In an embodiment, each user can input information specific to the user into a storable user profile, which can be used to provide targeted advertisements to the user based on the information included in the profile. In an embodiment, the user may issue a request for particular advertisements (e.g., dining advertisements, entertainment advertisements) to thereby receive selected advertisements specific to the user based on the user profile information. In each case, the selected advertisement can be selected from a plurality of different advertisements directed to the same product.

The above process can be implemented in a system where advertisements or group coupons are transmitted to the user via email. In this exemplary system, the Internet Service Provider (ISP) associated with the user can be trusted with or already have user profile information. For example, the ISP can maintain records of the user (e.g., based on billing information of the user) or can request additional information from the user (e.g., sex or age range), in order to provide a more directed and relevant advertisements or better market to the user based on the knowledge of the user's commercial interests and demographics.

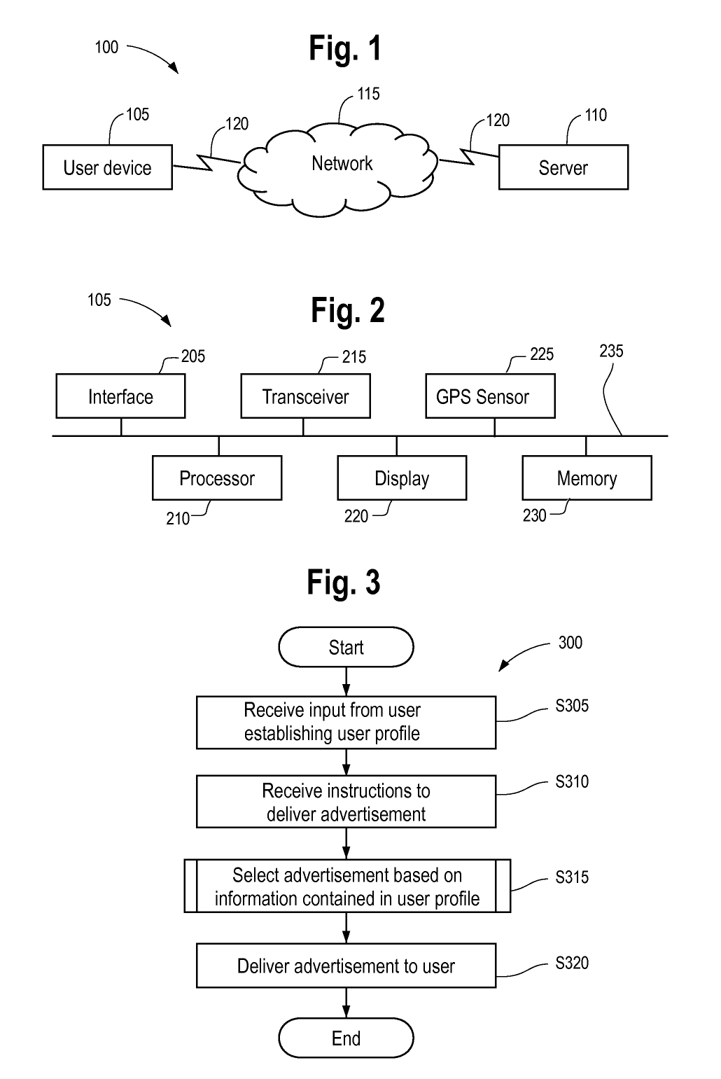

As shown in FIG. 1, an embodiment of the present invention includes a system 100 having a user device 105 operably coupled to a server 110 by way, for example, a network 115, by communication links 120. The user device 105 communicates with the server 110 to transmit data to and receive data from the server 110. Such data can include, for example, information specific to the user, user profile information, advertisements, requests from the user, and other inputs from the user.

The user device 105 can be a device or combination of devices of any type adapted for the acquisition, transmission and/or reception of data. By way of example, the user device 105 can include a smart phone (e.g. iPhone®), personal computer, voice and video telephone set, streaming audio and video media player, integrated intelligent digital television receiver, DVS receiver, work station, radio, personal digital assistant (PDA), mobile satellite receiver, GPS receiver, software system, social network or any combination of the above. In an embodiment, the user device 105 is a mobile device or computer that allows the user to enter information relevant to the user's interests and store the information in a user profile.

The server 110 can also be a device of any type adapted for the transmission and/or reception of data, and further adapted to store information to be transmitted to the user device 100. For example, the server 110 can include any device listed above with respect to the user device 105, or can include a non-transitory computer-readable recording medium, such as a hard drive, DVD, CD, flash drive, volatile or non-volatile memory, RAM, or any other type of data storage.

The network 115 may be a single network or a plurality of networks of the same or different type. For example, the network 115 may include a local telephone network (such as a Bell Atlantic telephone number) in connection with a long distance network (such as an AT&T long distance telephone network). Further, the network 115 may be a data network, an Intranet, the Internet or a telecommunications network in communication with a data network. Any combination of telecommunications and data networks may be used without departing from the spirit and scope of the present application. For purposes of discussion, it will be assumed that the network 115 is the Internet.

The communication links 120 may be any type of connection adapted for the transmission of information. Some examples include conventional telephone lines, fiber optic lines, direct serial connections, cellular telephone connections, satellite communication links, local area networks (LANs), intranets, and the like.

The user profile can be any form of data that includes information relevant to the user. For example, the user profile can be an interface that the user can custom fill with relevant information so that the user is targeted with advertisements or deal of the day coupons based on the custom-filled information. Alternately, the user profile can be a read-only screen or non-viewable document that includes the relevant user information if, for example, the user entered the relevant information into the form and transmitted the form physically to the profile manager. Any other type of user profile can be used without departing from the spirit and scope of the present application.

The user profile serves as a body of data that identifies the unique commercial interests of the user, as defined by the user, so that the user can be subjected to relevant advertisements and deal of the day coupons. The user profile can be completed by the user in advance, for example, when setting up a membership to a particular webpage, or on-demand, for example, when searching for deal of the day coupons relevant to the user's interests. The user can thus focus advertising and deal of the day coupons on the specific interests and qualities of the person (e.g., demographic, age, sex) rather than being subjected to irrelevant solicitations.

FIG. 2 illustrates an embodiment of a user device 105 according to the present application. The user device 105 can allow the user to enter information to be stored in a user profile or to request an advertisement from the user. As shown, the user device 105 includes an interface 205, processor 210, transceiver 215, display 220, GPS sensor 225 and memory 230 operatively coupled to one another by a connecting medium 235. Although the schematic diagram of FIG. 2 illustrates the features of the user device 105 as physically coupled together, the present invention is not so limited. Rather, the features of the user device 105 can be operably coupled by wireless networks or through the Internet, for example.

The interface 205 allows the user to input information or commands into the user device 105 and to transmit the information or command to the server 110 via the network 115. For example, the interface 205 can allow the user to input information specific to the user to be stored in a user profile, identifying data of the user (such as log in and password information, for example), product information, or any other data or information useful to the system 100. The interface 205 can be a separate interface from the display 220 or can be integrated within the display 220 as, for example, a touch screen. By way of example, the interface 205 can include a keyboard, mouse, touch screen, audio recorder, audio transmitter, member pad, or any other device that allows for the entry of information from a user.

The processor 210 is adapted to facilitate communications between the various components of the user device 105. The processor 210 can be any type of processor or processors that alone, or in combination, facilitate communications and computations within the user device 105 and, together with the transceiver 215, transmit information from the user device 105 to external devices. For example, the processor 210 can be a desktop or mobile processor, a microprocessor, a single-core or a multi-core processor.

The transceiver 215 can be any device adapted to transmit data from the user device 100 and receive data from an external data source. By way of example, the transceiver 215 can be any type of radio transmission antenna, cellular antenna, hardwired transceiver, or any other type of wired or wireless transceiver that is capable of communicating with an external device.

The GPS sensor 225 can allow the user device 105 to determine its current GPS coordinates and thus determine the user's geographic orientation. The GPS coordinates can then be used to allow the user to more easily enter the user's location into the user profile.

The memory 230 can store any information including user profile information, identifying information of the user, firmware or software relevant to the system 100, current or past on-demand requests from the user, product information, or any other information or data deemed to be useful to the system 100. The memory 230 can also store an operating system for the user device 105 or any other software or data that may be necessary for the user device 105 to function. Similar to the server 110 discussed above, the memory 230 can include any non-transitory computer-readable recording medium, such as a hard drive, DVD, CD, flash drive, volatile or non-volatile memory, RAM, or any other type of data storage.

The connecting medium 235 can be any structure or combination of structures that helps facilitate communication between the components of the user device 105. For example, the connecting medium 235 can be a bus, or can be a series of wireless transceivers that are each connected to one another through a wireless network. The connecting medium 235 is not limited so long as the features of the user device 105 can be connected to one another in a communicable fashion.

FIG. 3 illustrates a process 300 according to the present application where advertisements are selected to be more closely tailored to the user's specific interests based on information that is stored in the user's profile. The advertisements can be selected from a plurality of advertisements for the same product to provide a more tailored advertisement to the user based on the user information stored in the user profile.

As shown, the process starts and proceeds to step S305 where the user information is input so as to establish a user profile. The user can input the information in any manner, such as by entering the input into the interface 205 of the user device 105 or by entering the input into another computer, mobile device, or computerized machine. The user could also complete a form providing their identifying information and either mail or otherwise send the form to a central location to establish the user profile. Any other manner of entering information to establish a user profile can be implemented without departing from the spirit and scope of the present application.

The user profile of the present invention is advantageous because it is created based on user-input and based on the desired type of advertisement of the user. The user can take control of the advertisements and deal of the day coupons that the user is subjected to through the custom input of user information. Individual advertisements can be sent to the user in one form or another based on the user's custom input information. For example, the user can be subjected to an advertisement directed to males based on the user inputting “male” as his sex. However, a female can be subjected to an advertisement for the same product if the user inputs “female” for her sex.

Once the user profile has been established in S305, the user and/or the vendor can transmit instructions to the server 110 requesting that an advertisement be sent to the user or the user device 105. The vendor can manually or automatically establish a practice where the user is periodically sent advertisements for a particular product based on any form of information relevant to the user's consumer behavior. Similarly, the user can transmit a request to receive an advertisement, for example, requesting that a deal-of-the-day advertisement or group coupon advertisement be sent to the user. The on-demand request can include some or all of the information stored in the user's profile, or can request specific criteria for the user to input separate from the user profile to create a more closely tailored advertisement for a specific product.

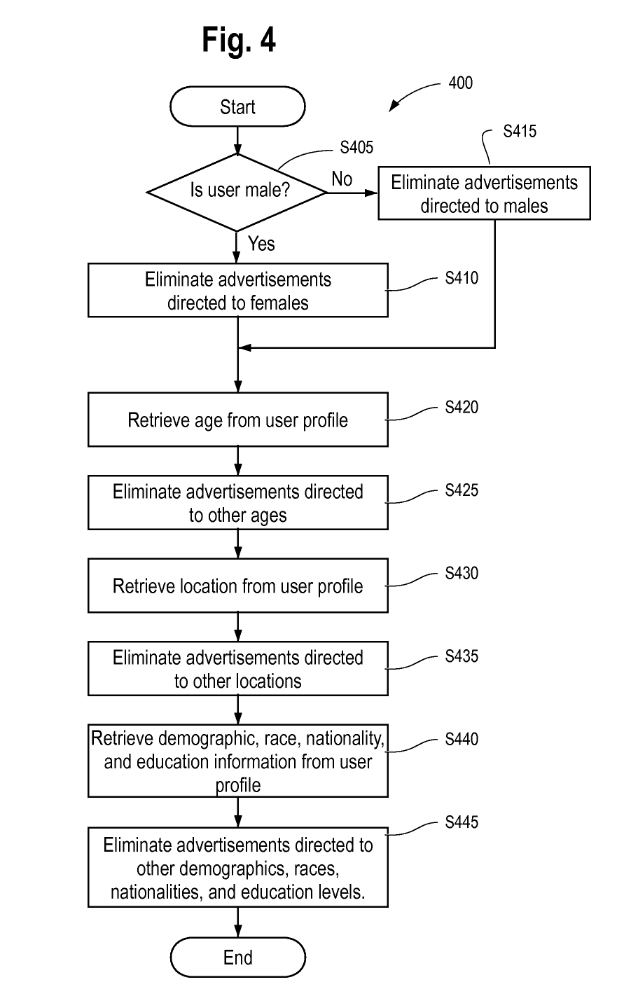

Once the advertisement is requested by either the user or the vendor 5310, the advertisement can be selected S315 based on the user information stored in the user profile or input via the on-demand request. In step S315, the system 100 selects a particular advertisement choice among a plurality of advertisement choices to be delivered to the user as the selected advertisement. Each of the advertisements can be associated with a common product or service. For example, a first advertisement choice can include a picture of a Chicago sports star eating a potato chip (so as to be directed at a Chicago sports fan) while a second advertisement choice can include a St. Louis sports star eating a potato chip (so as to be directed at a St. Louis sports fan), where both advertisement choices relate to the same brand of potato chips. The process according to step S315 will be discussed below in more detail with respect to FIG. 4.

Once the advertisement has been selected from the advertisement choices S315, the process proceeds to step S320 where the advertisement is delivered to the user. The advertisement can be delivered in any manner, for example, by transmitting the advertisement to the user's computer or mobile device, by transmitting the advertisement to a nearby display, by transmitting audio signals representing the advertisement with or without a corresponding video link, by sending an image to the user, or by sending a URL or internet link to the user's computer or mobile device, for example. Any other manner of transmitting data representing the selected advertisement can be used for the delivery method without departing from the spirit and scope of the present application.

A process 400 for selecting an advertisement choice will now be discussed with reference to FIG. 4. The process according to FIG. 4 selects a particular advertising choice among a plurality of advertising choices directed to the same product. For example, the process 400 can choose an advertisement that includes a picture of a celebrity close to the user's age so as not to subject an older user with advertisements more closely tailored to younger consumers, or vice versa.

As shown, the process 400 begins and proceeds to step S405 where it is determined whether the user is male or female based on the information obtained from the user's profile or the information input via the on-demand request system. If it is determined that the user is male, the system proceeds to step S410 where the system 100 eliminates among the advertisement choices any advertisements that are considered to be directed to females. However, if it is determined that the user is female based on the input information, the process proceeds to step S415 where advertisements directed to males are eliminated. Following steps S405-S415, the process proceeds to step S420.

In step S420, the age is retrieved from the user profile or from input, and advertisements directed to other ages are eliminated in S425. Similarly, in S430, the user's location is retrieved from either the user profile or the on-demand input and in S435 the advertisements directed to locations other than the user's location are eliminated. In both steps S420 and S430, the age and location of the user can be determined within a specific range to account for similarities in the range. For example, the age of the user can be determined to be between 26-30 years of age to account for the social similarities within this age group. Similarly, the user's location can be established within a 50 mile radius to account for geographic similarities within the 50 mile radius and so as to not exclude relevant advertisement choices.

Following steps S420-S435, the process proceeds to step S440 where the demographic, race, nationality, and/or educational level of the user is retrieved from the user profile or the on-demand input 5440 and compared against the advertisement choices S445 to eliminate advertisement choices that do not correspond to the criteria retrieved in step S440. Following step 445, the process ends.

The selection process of FIG. 4 focuses the advertisement on the person, rather than the product, by selecting a specific advertisement for the same product based on the individual qualities of the user. For example, the user can be subjected to an advertisement based on their race, nationality, sex, occupation, demographic, salary, or any other factor that can drive a user's commercial interests. The same product or service can include a plurality of advertisements so that the user can be targeted based on their individual interests and qualities, and not based on the product itself. Of course, the product could also be considered a relevant factor when deciding what advertisement to send to the user.

It should be appreciated that all of the steps illustrated in FIGS. 3 and 4 are optional and can be implemented in any order or by omitting any of the steps listed. For example, steps S440 and S445 can be omitted in FIG. 4 and the process can select the appropriate advertisement choice without taking into account the user's demographic, race, nationality, and/or education information.

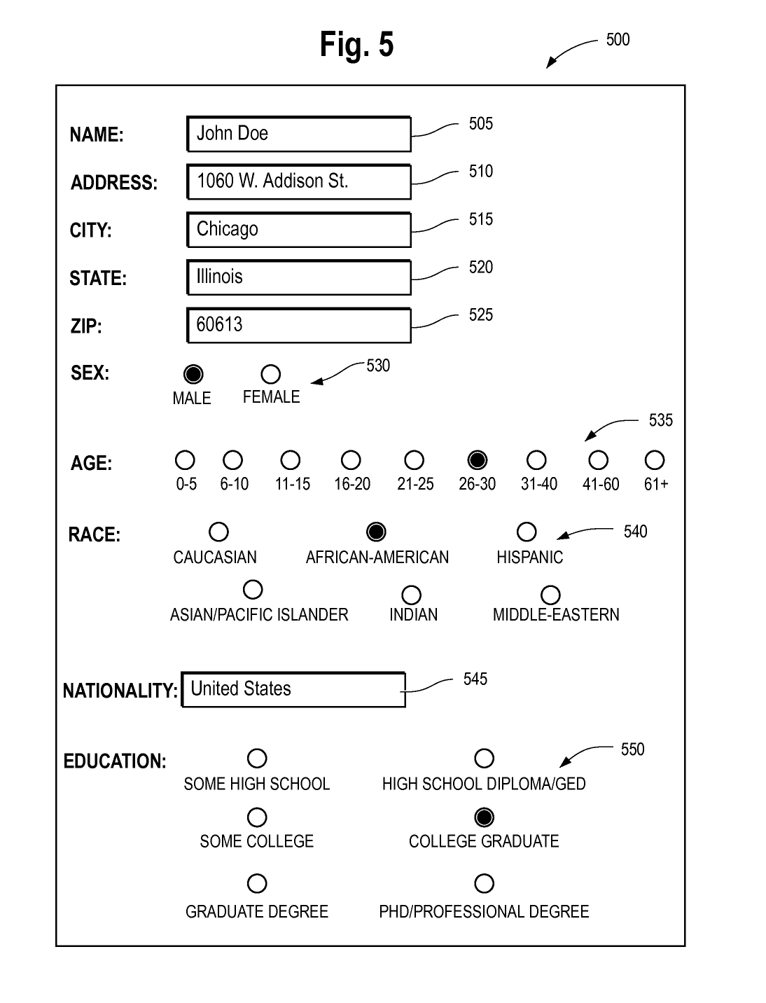

FIG. 5 illustrates a user profile according to the present application where a user has input information. Alternately, FIG. 5 can illustrate the request input screen in which a user can input selected information and custom-design a profile for a particular on-demand advertisement request. The user need not enter all of the information into the profile or form, and can enter only that information that the user deems will be helpful in delivering more targeted advertisements. Alternately, the user need not know that the information provided will be utilized for advertising purposes, or consent for use of the information can be provided in an agreement with the webpage issuing the template.

As shown, the user profile 500 includes inputs for the user's name 505, address 510, city 515, state 520, zip code 525, sex 530, age 535, race 540, nationality 545, and education 550. The inputs can be in the form of a text entry, where the user enters text (e.g., “John Doe” in the name input 505) or can be in the form of a selection entry, where the user selects from a finite choice of options (e.g., “male” for the sex entry 530). Also, the input can be in the form of a pull down menu where a finite number of options are available, but the number of finite options is large (e.g., the state input 520). Any other form of input can be instituted without departing from the spirit and scope of the present application.

The term “user profile” as used throughout this application can include both the user profile illustrated in FIG. 5, or other user profiles illustrating other information, or can include an on-demand entry of information in a template or form. The term “user profile” is also not intended to be limited to profiles in which the information was input previously by the user and stored either on the server 110 or the user device 105. Rather, the user profile can be completed any time prior to receiving the advertisement.

The advertisement has been discussed above as being one advertisement selected from a plurality of advertisements for a single product or service. However, the advertisement can be a selected advertisement from a plurality of advertisements directed to a plurality of products or services, where the products or services are tailored towards the user's specific information input into the user profile or on-demand template. The selected advertisement need not be one advertisement among a plurality of advertisements directed to the same product or service.

The user device 105 has been discussed as including a plurality of features including the interface 205, processor 210, transceiver 215, display 220, GPS sensor 225, or memory 230. However, any or all of the above features can be omitted from the user device 105 without departing from the spirit and scope of the present application. For example, the user device 105 need not include a GPS sensor 225 and the user can manually input the user's location by entering text into the user profile.

The advertisement choices discussed above are considered to be directed to a particular criteria (e.g., directed to males, directed to people aged 26-30, etc.). The manner of determining how an advertisement is directed to a particular criteria is not limited. For example, the vendor can provide data with the advertisement that indicates which criteria the advertisement is directed to. Alternately, the advertisement can be automatically determined as directed to a particular sex, age, location or demographic based on the users that the advertisement was transmitted to. Any other manner of providing advertisement criteria can be implemented without departing from the spirit and scope of the present application.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A method of providing advertising material to a user comprising:
receiving a request to transmit an advertisement to the user;
receiving input from the user to establish a user profile including information specific to the user;
selecting, by a processor, a selected advertisement from a plurality of advertisements based on the information specific to the user, wherein the plurality of the advertisements represents a same product or service among a plurality of products or services offered by a company;
delivering the selected advertisement to the user; and
periodically repeating the step of selecting the selected advertisement and delivering the selected advertisement for the same product or service based on the user-entered information specific to the user.

2. The method of claim 1, wherein the information specific to the user includes at least one of a sex, age, race, nationality, location, income, occupation, and education level of the user.

3. The method of claim 2, wherein the step of selecting one of a plurality of advertisement choices includes:
receiving at least one of the location, sex, age, race, nationality, income, occupation and education level of the user from the information; and
selecting the advertisements that correspond to the information.

4. A method of providing advertising material to a user comprising:
receiving a request from the user to receive an advertisement, the request including information specific to the user and input by the user;
selecting, by a processor, a selected advertisement from a plurality of advertisements based on the information specific to the user, wherein the plurality of the advertisements represents a same product or service among a plurality of products or services offered by a company; and
delivering the selected advertisement to the user; and
periodically repeating the step of selecting the selected advertisement and delivering the selected advertisement for the same product or service based on the user-entered information specific to the user.

5. The method of claim 4, wherein the information specific to the user includes at least one of a sex, age, race, nationality, location, income, occupation and education level of the user.

6. The method of claim 5, wherein the step of selecting one of a plurality of advertisements includes:
receiving at least one of the location, sex, age, race, nationality, income, occupation, and education level of the user from the information; and
selecting the advertisement choices that correspond to the information.

7. A system for providing advertising material to a user comprising:
an interface adapted to receive input by the user;
a processor operatively coupled to the interface; and
a computer-readable medium operatively coupled to the processor and adapted to store a computer program having instructions for:
receiving input from the user to establish a user profile including information specific to the user;
receiving a request to transmit an advertisement to the user;
selecting a selected advertisement from a plurality of advertisements based on the information specific to the user, wherein each of the advertisements represents a same product or service among a plurality of products or services offered by a company;
causing the delivery of the selected advertisement to the user; and
periodically repeating the step of selecting the selected advertisement and causing the delivery of the selected advertisement for the same product or service based on the user-entered information specific to the user.

8. The system of claim 7, wherein the information specific to the user includes at least one of a sex, age, race, nationality, location, income, occupation, and education level of the user.

9. The system of claim 8, wherein the instructions for selecting one of a plurality of advertisements includes:
receiving at least one of the location, sex, age, race, nationality, income, occupation, and education level of the user from the information; and
selecting the advertisements that correspond to the information.

10. A user device for providing advertising material to a user comprising:
an interface adapted to receive input by the user;
a processor operatively coupled to the interface; and
a computer-readable medium operatively coupled to the processor and adapted to store a computer program having instructions for:
receiving a request from the user to receive an advertisement, the request including information specific to the user;
selecting a selected advertisement from a plurality of advertisements based on the information specific to the user, wherein a plurality of the advertisements represents a same product or service among a plurality of products or services offered by a company;
causing the delivery of the selected advertisement to the user; and
periodically repeating the step of selecting the selected advertisement and causing the delivery of the selected advertisement for the same product or service based on the user-entered information specific to the user.

11. The user device of claim 10, wherein the information specific to the user is at least one of a sex, age, race, nationality, location, income, occupation, and education level of the user.

12. The user device of claim 10, wherein the instructions for selecting one of a plurality of advertisements includes:
receiving, as user information, at least one of a location, sex, age, race, nationality, income, occupation, and education level of the user from the user profile; and
selecting the advertisement choices that correspond to the user information.
